(19) United States
(12) Patent Application Publication
(10) Pub. No.: US 2014/0073420 A1
(43) Pub. Date: Mar. 13, 2014

(54) SYSTEM AND METHOD FOR OPTIMIZING USER VALUE IN AN ONLINE ENVIRONMENT

(71) Applicant: Downing Matthew, Flagstaff Hill (AU)

(72) Inventor: Downing Matthew, Flagstaff Hill (AU)

(21) Appl. No.: 13/718,962

(22) Filed: Dec. 18, 2012

Related U.S. Application Data
(60) Provisional application No. 61/698,285, filed on Sep. 7, 2012.

(51) Int. Cl. A63F 13/12

(52) U.S. Cl. CPC A63F 13/12
USPC 463/29

(57) ABSTRACT

A processor-based system for optimizing end-user value for a web or mobile application, the system is provided. The system provides a module in communication with the application, wherein the module is configured to monitor an end-user behavior on the application, analyze the end-user behavior; and perform an action based on the analysis, wherein the action comprises transmitting an offer to the end-user or setting an indicia by a merchant. A method for optimizing user value is also provided.

### CROSS-REFERENCE TO RELATED APPLICATION

The present Utility patent application claims the priority benefit of the U.S. provisional application for patent Ser. No. 61/698,285 filed on Sep. 12, 2012 entitled A System and Method for Enhancing User Value in a Networked environment, under 35 U.S.C. 119(e). The contents of this related provisional application are incorporated herein by reference for all purposes.

### FIELD OF THE INVENTION

The present invention relates generally to networked and web-based computer platforms and games. More particularly, the invention relates to the quantitative measurement and processing of user behavior within the operator distribution platform that hosts and serves games or applications to its users, and optimization of value based on said behavior, while optimizing merchant pricing offers in real-time.

### BACKGROUND OF THE INVENTION

The development of the Internet and wireless protocol has led to a vast increase in human interaction via social networking, online gaming, and other networked mobile applications and computer platforms. This has allowed people (also referred to herein as “users”) in various parts of the world to communicate and interact on various gaming levels. For example, massively multiplayer online games (MMOGs) have been developed which are capable of supporting hundreds of thousands of players simultaneously. These games may include various “online fantasy worlds” in which global user can communicate and interact simultaneously. In these games, players can cooperate and compete with each other on a large scale, and interact meaningfully with other users around the globe.

Wireless protocol, and in particular Mobile application development has led to a new market of goods and services not realized prior to the development of Mobile Application stores. For example, a user using their mobile device (e.g., smartphone) can go to a mobile application distribution platform such as the Apple App Store, Google Play, Windows Phone Store and BlackBerry App World.

These distribution platforms allow the general public to publish applications on its platform available to all users for download. Publishers may use a software development kit (or driver development kit) provided by the platform providers or other provider which assist publishers in developing their Apps. The development kits may allow publishers to interface to different programming languages using an application programming interface (API).

Mobile Applications, also referred to herein as “apps” have a wide variety of uses. Platforms may include, for example, maps, business systems, online gaming, translation engines, television, finance tools, and the like. In the context of gaming, the development of many mobile Apps, in some gaming arenas, has led to an online economy of virtual goods. For example, users may purchase goods from a developer to enhance their online presence and improve or further develop their online fantasy world. There are various types of virtual goods (also referred to as in-game assets or rewards) that a user can obtain within the game. For example, a user may acquire game points, gold coins or rings, points, character levels, character attributes, virtual currency, game keys, password, or other in-game items of value. In some online games, user or players exchange real-world currency (e.g., dollars) for access to the above-recited items.

In many of these online and mobile games, users also may encounter various types of obstacles that a player must overcome to advance within the game. In-game obstacles can include tasks, puzzles, opponents, levels, gates, actions, etc. In these games, a user or player may exchange real-world currency for access to the above-recited items.

In yet other online-games, users may be subject to certain promotions or similar communications based on their game-play. In each of the scenarios referred to above, users, and their actions while gaming, may equate to a great deal of monetary value for developers.

Online poker tournaments and gaming applications such as blackjack and craps have also become extremely popular. Many developers rely heavily on the number of participants that play, and the amount of time they spend playing for advertising revenue.

To quantify and capitalize on these values, many companies and developer use key performance indicators (KPIs), which are a set of indicia used to measure business performance. For example, investment banks will often take into account the appropriate capital structure for a certain capital outlay based on the probability distribution proportional to the profit from the money invested. In other industries, KPIs are more similar to analytics.

Many of the current analytical monitoring systems display performance indicators for certain indicia which a developer can analyze. As a result of the analysis, the developers can target specific users in an attempt to increase user value (via strategic marketing campaigns).

However, the information gained from these analytical monitoring systems are not predictive in nature, and require ex-post facto analysis before taking action steps. The systems do not react in real-time to increase value of a specific user, and thus, do not increase value at a point of impression.

Furthermore, none of the known systems and methods for tracking KPIs are introducible to specific online games, while also being fully configurable to the specific game while using appropriate indicia. Lastly, none of known system provide suggestive measures to the developer during game development as to certain indicia to increase user value, while optimizing merchant pricing offers in real time in a scalable manner.

Accordingly, there is a need for a system and method to increase user value at a point of impression, whether during game play or during platform development.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram depicting an exemplary client/server system which may be used by an exemplary web-enabled/networked embodiment of the present invention;

FIG. 2 is a detailed block diagram depicting an exemplary client/server system which may be used by an exemplary web-enabled/networked embodiment of the present invention;

FIG. 3 is a block diagram depicting a more detailed view of the server side and module applicable to exemplary embodiments of the present invention.

FIG. 4a is a block diagram depicting a more detailed view of the client side and module.

FIG. 4b is a block diagram depicting another exemplary embodiment of the present invention.

FIG. 5 is a block diagram depicting a more detailed view of the system applicable with exemplary embodiments of the present invention.

FIG. 6a is a block diagram representing a system architecture applicable to embodiments of the present invention.

FIG. 6b is a flowchart showing the core logic of a component within the system architecture described in FIG. 6a.

FIG. 7 illustrates a flowchart depicting a method for increasing user value, in accordance with an embodiment of the present invention.

FIG. 8 illustrates a flowchart depicting a method for increasing user value and optimizing merchant, in accordance with an embodiment of the present invention.

Unless otherwise indicated illustrations in the figures are not necessarily drawn to scale.

### SUMMARY OF THE INVENTION

To achieve the forgoing and other aspects and in accordance with the purpose of the invention, a method, system and computer program product for increasing user value is presented.

In an embodiment of the present invention, a method for optimizing end-user value for a web or mobile application, the method executed by one or more computing processors is provided. The method comprises monitoring an end-user behavior on the application; analyzing the end-user behavior; and performing an action based on the analysis, wherein the action comprises transmitting an offer to the end-user or setting an indicia by a merchant.

In an embodiment of the present invention, a processor-based system for optimizing end-user value for a web or mobile application is provided, the system comprising a module in communication with the application, wherein the module is configured to monitor an end-user behavior on the application; analyze the end-user behavior; and perform an action based on the analysis, wherein the action comprises transmitting an offer to the end-user or setting an indicia by a merchant.

Other features, advantages, and aspects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

While exemplary embodiments of the present invention will be described with reference to certain types of mobile applications, a skilled artisan will realize that embodiments of the invention are applicable to any type of mobile application and/or web module in which quantitative analyses on user value is beneficial.

As used herein, a “merchant” is an application developer or organization using the multi-tenant platform to drive its real-time pricing decisions. The merchant may sell goods and/or services to its end users through the merchant's software application. The merchant's staff administers their use of the platform through a control panel built on platform interfaces, while the merchant's application interfaces directly with the platform API.

As used herein, an “offer” is a good, price, and duration that the merchant extends to its end users. In an exemplary embodiment, an offer can be as simple as “Buy the virtual battle axe for just price X”. An offer in other embodiments to more complex offers such as “Buy the silver battle axe on sale, at price Y for the next Y hours, regular price Z”. Offer expiration may be set in an absolute date/time, or relative to when the offer is presented to the user, or a combination.

The application may present several goods, such as color variations on the same item or multiple items of similar value to end users. These variations may be tied to the application to a single underlying offer from the platform, or another alternative may be represented as distinct products within the platform. Distinct products may be priced independently unless the merchant sets constraints on the platform to preclude such experimentation.

As used herein, an “offer set” is a collection of offers that the merchant presents concurrently to an end user. An offer set may be presented as an exclusive choice, such as “buy a silver battle axe for price X or a gold battle axe for price Y”. Or the offer set may allow one or more item to be purchased at each offer. Offer sets may comprise on unrelated goods.

In embodiments of the present invention, merchants may specify a plurality of constraints on the experiments or tests performed by the present invention. Constraints may comprise the following examples:

An “eligibility constraint” is the merchant's restriction on which users are eligible for each offer. For example, an eligibility constraint might in effect say “You are eligible for this special price because you've achieved platinum medallion level in our Frequent Fighter program” or “This offer is good for all of our customers.” This mechanism allows the merchant to limit favorable pricing to its most valued customers. The valuation of a user may be based on key performance indicators within the applications and adjusted by the influence has on other users to spend. It may be further used as an explanation for why pricing may be different for users who may be comparing offer prices with one another. In exemplary embodiments, an end user may qualify for an offer through multiple tests. In that case the platform may arbitrarily select which reason to indicate to end users, or delegate that discretion to the application.

As used herein, “an input variable constraint” is a merchant's restriction on the input variables that may be used by a pricing algorithm to determine the offer for a specific user. For example, “The price shall not vary depending on the gender of the customer.” This type of constraint allows merchants to restrict experimentation by the platform not only to make the parameters of experimentation more transparent to the merchant and guided by their other knowledge, but also may be more acceptable to end users or regulatory scrutiny.

As used herein, an “individual offer constraint” is a merchant's restriction on the form of offer, the output of a pricing algorithm. For example, “the offer price shall range between 1.99 and 9.99 in increments of 0.05.” Individual offer constraints may also govern exchange rates when there is a choice of currency offered, e.g. “The offer price may be translated to 100 Frequent Fighter points per dollar, rounded to the nearest 10.” Just as offer constraints can govern the price, they may similarly express limits to the time interval range and increments allowed for expiration times. This type of constraint allows merchants to uphold any agreements they have on minimum or maximum price, as well as choose prices to be at fewer discrete levels, and present users with the type of prices they are accustomed to seeing that are decided by humans.

A “relative offer constraint” is a merchant's restriction on the relative values between offers that coincide in the offer set, e.g. “The offer price for the gold battle axe shall be at least 50% more than the silver battle axe,” or “Longbows and crossbows should always be at the same price.” As it could be possible for multiple relative constraints to result in circular evaluation or be in conflict so that no valid offer is possible, the platform may enforce precedence ordering or some other means of arbitration, such as using a default price and generating an alert to the merchant's administrator.

As used herein, an “offer set constraint” is a merchant's restrictions on offers within a set. Examples of offer set constraints include “All offers in this set will expire upon expiration of the shortest duration offer,” or “Only one of the items offered may be purchased.”

As used herein, an “offer stickiness constraint” is a time interval set by the merchant to ensure when an offer is presented to an end user and then re-requested by the application that the end user continues to get a consistent offer for a limited period of time.

As used herein, a “constraint set” is a combination of one or more of the above constraints taken together. Within each constraint set, the platform performs a series of offer experiments. The merchant may choose to analyze the results of each offer to in order to define new constraint sets.

In exemplary embodiments of the present invention, the merchant will configure more than one constraint set that are concurrently in effect. Optionally, one of the constraint sets may be identified as a “baseline” and have no or limited variation allowed, in order to demonstrate the performance advantage of using the platform.

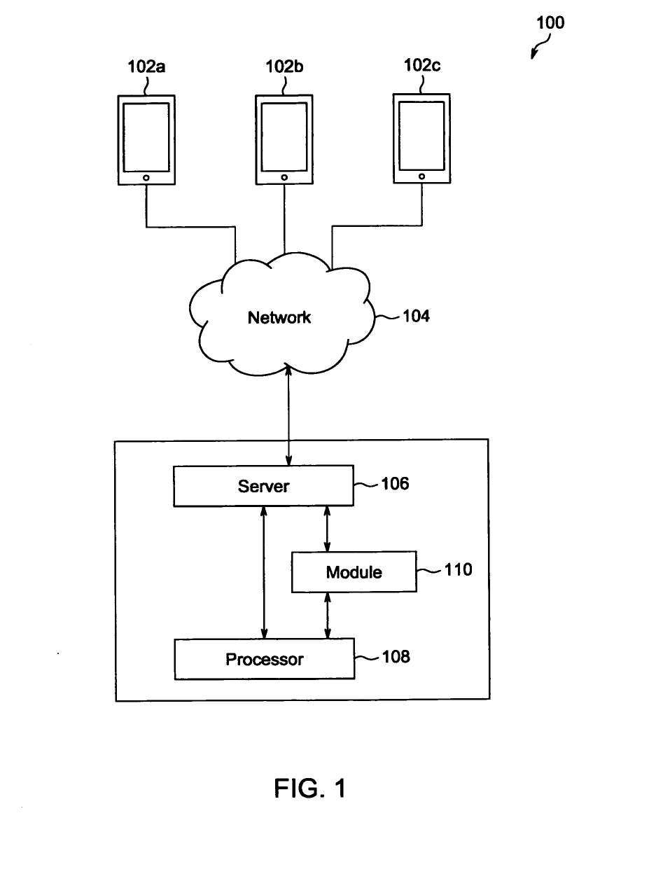

In exemplary embodiments, of the present invention, to be described in greater detail in relation to FIGS. 1-8, if the user is eligible for more than one constraint set, the platform assigns one by chance, using a random-number generator (RNG) against a weighted probability applied to each constraint set. The merchant can set a mix weight constraint on the minimum and maximum weight to allocate to each constraint set. The platform can vary the weighting, according to performance of the various constraint sets, within the mix weight constraint.

A first embodiment of the present invention will be described which provides means and methods for increasing user value during an online gaming experience and optimizing pricing schema for a merchant.

Referring now to FIG. 1, a block diagram depicting an exemplary client/server system which may be used together with an exemplary embodiment of the present invention is shown generally at 100.

Clients 102a, 102b and 102c represent user devices (e.g., smartphones) at which one or more independent users (also referred to herein as “players” or “garners”) may participate in a function. The clients 102a, 102b and 102c, in this exemplary embodiments, are smart phones. However, it should be appreciated that clients 102a-c may also include personal digital assistants, tablet devices, e-readers, wireless music devices and any other personal computing device such as desktops and laptops, which includes at least one of a display, processor, memory or input or output means, together with any electronic device that is used as a platform for audio-visual media including games, mobile applications, books, movies, music, and web content. Further, it should be noted that while only three clients 102a, 102b and 102 are shown, the present methods and systems are applicable to large volume networks in the order of hundreds of thousands or millions of clients.

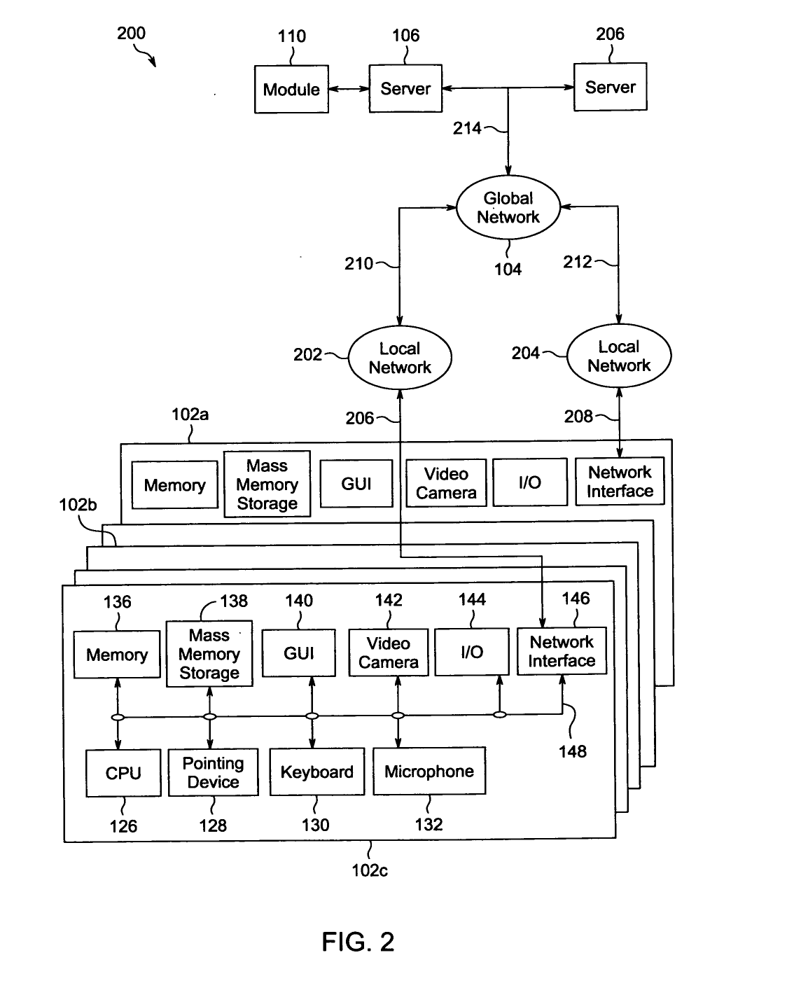

The clients 102a-c, in an embodiment of the present invention, may be communicatively connected to each other, and further communicably connected to at least a server 106 via network 104. The server 106 may be in further communication with a computing processor 108 and a module 110, which will be discussed in further detail with relation to FIGS. 2-4.

Referring now to FIG. 2, a more detailed block diagram depicting an exemplary client/server system which may be used together with an exemplary embodiment of the present invention, which is shown generally at sd00.

In this exemplary embodiment, the system 200 includes clients with a sampling of clients denoted as a client 102a, 102b and 102c, together with local networks 202 and 204, the global network 104 and a plurality of servers 106.

In this exemplary embodiment of the present invention, client 102c may communicate bi-directionally connected with local network 202 via a communication channel 206. Client 102a may communicate bi-directionally with local network 204 via a communication channel 208. Local network 106 may communicate bi-directionally with global network 104 via a communication channel 210. Local network 204 may communicate bi-directionally with global network 104 via a communication channel 212. While only two distinct local networks are shown, exponentially more networks may be in communication with the servers at any one time.

Global network 104 may communicate bi-directionally with server 106 and server 206 via a communication channel 214. Furthermore, clients 102a-c, local networks 202, 204, global network 104 and servers 106, 206 may each communicate bi-directionally with each other over global network 104. There are also generally one or more gateways (not shown) connecting the local networks 206, 208 and the servers 106, 206 to the global network 104.

The global network 104 may comprise the Internet, local area networks (LANs), wide area networks (WANs), wired telephone networks, wireless networks, or any other network supporting data communication between respective clients, developers, servers, and the like.

Client 102a-c, which in this exemplary embodiment are smart phones, may comprise various known hardware, software, and firmware. For example, the smart phones may comprise a CPU 126, a sensory representation (a visual, auditory, or tactile output such as a graphic display, a tone, or a vibration) 128, a keyboard/touchpad 130, a microphone 132, a memory 136, a mass memory storage 138, a graphical user interface 140, a video camera 142, an input/output interface 144 and a network interface 146. The client may also include removable media devices (e.g., memory cards, etc).

CPU 126 may be comprised of a single processor or multiple processors. CPU 126 may be of various types including micro-controllers (e.g., with embedded RAM/ROM) and microprocessors such as programmable devices (e.g., RISC or CISC based, or CPLDs and FPGAs) and devices not capable of being programmed such as gate array ASICs (Application Specific Integrated Circuits) or general purpose microprocessors.

Memory 136 is used to transfer data and instructions to CPU 126 in a bi-directional manner. Memory 136, as discussed previously, may include any suitable computer-readable media, intended for data storage, such as those described above excluding any wired or wireless transmissions unless specifically noted. Mass memory storage 138 may also be coupled bi-directionally to CPU 126 and provides additional data storage capacity and may include any of the computer-readable media described above. Mass memory storage 138 may be used to store programs, data and the like and is typically a secondary storage medium such as a hard disk. It will be appreciated that the information retained within mass memory storage 138, may, in appropriate cases, be incorporated in standard fashion as part of memory 136 as virtual memory.

CPU 126 optionally may be coupled to network interface 146 which enables communication with an external device such as a database or a computer or telecommunications or internet network using an external connection shown generally as communication channel 116, which may be implemented as a hardwired or wireless communications link using suitable conventional technologies. With such a connection, CPU 126 might receive information from the network, or might output information to a network in the course of performing the method steps described in the teachings of the present invention. Smartphones may communicate via remote connectivity including, but not limited to the Internet, Satellite networks, Cell Phone networks, other wireless networks and standards such as 802.11, 80211.b, 802.11g, or similar wireless LAN operating standards, or Bluetooth technologies, infrared connections, or any other similar technologies or other technologies such as those described above that permit the sending and/or receiving and/or processing of electronic information in either an encrypted or unencrypted format.

In an embodiment of the present invention, a module 110 is in is implementable or configurable with an existing mobile platform hosted on the server 106. For example, the module may be an application programming interface (API) that may be written into a downloadable mobile application either during programming initially or as an additional code post-development.

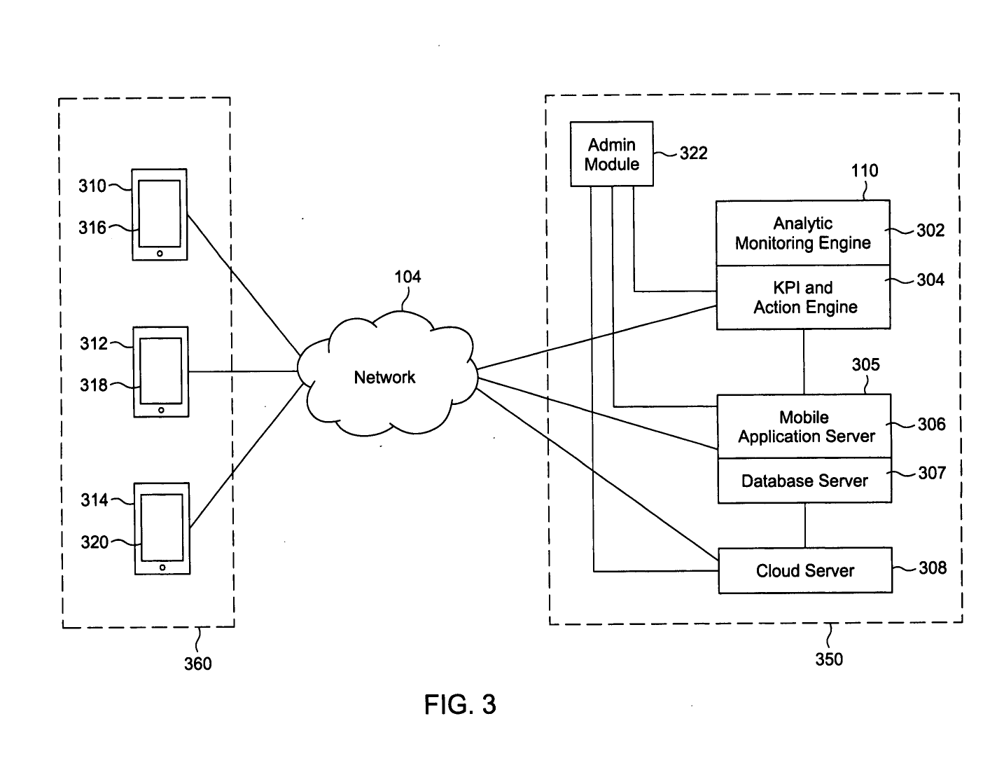

Referring now to FIG. 3, a system for monitoring and processing user value in an online or mobile environment is provided at reference numeral 300. The system 300 comprises a server side 350 and a client side 360 in communication via network 104. The system 300 further comprises mobile devices 310, 312, and 314, which are analogous to each of clients 102a-c of FIG. 1 and FIG. 2. Each represents an end user. The system 300 further comprises module 110, which includes analytic monitoring engine 302 and KPI action engine 304. The system 300 further comprises mobile application server 306 and cloud server 308. Each element of the system is communicably coupled to the network 104 wireless networks, LAN operating standards, and the like.

The mobile application server 306 may store a plurality of, mobile apps or games that are downloadable onto smart phones 310, 312, 314 via network 104. Examples of execution environments applicable with the present invention include Android, iOS, BlackBerry, HP webOS, Symbian OS, Bada from Samsung, and Windows Mobile. In optional embodiments of the present inventions, the mobile apps may be pre-installed on phones during manufacture, or delivered as web applications using server-side or client-side processing (e.g. JavaScript) to provide an “application-like” experience within a web browser. The mobile devices 310, 312, 314 comprise hardware, software and firmware as described in FIG. 2, and are configured to store and execute the applications when prompted by a user.

While the mobile application server 306 may be a dedicated application server for running certain software applications (e.g., gaming), the housing 305 may also comprise database server 307, which is configured to provide database services to mobile application server 306 and each of the analytic monitoring engine 302 and KPI/action engine 304. In optional embodiments, the database server 307 be a stand-alone server and may comprise MySQL and rely exclusively on the client-server model for database access.

Still with reference to FIG. 3, the system may comprise cloud server 308 connected to the network 104 and also the mobile application server 306 where necessary. The cloud server 308 is configured to communicate with each of the mobile devices 310, 312, 314 over the network 104, to send and retrieve user data associated with any cloud-specific applications. In this regard, the cloud server is configured to further communicate said user data to each of the mobile application server and the module 110.

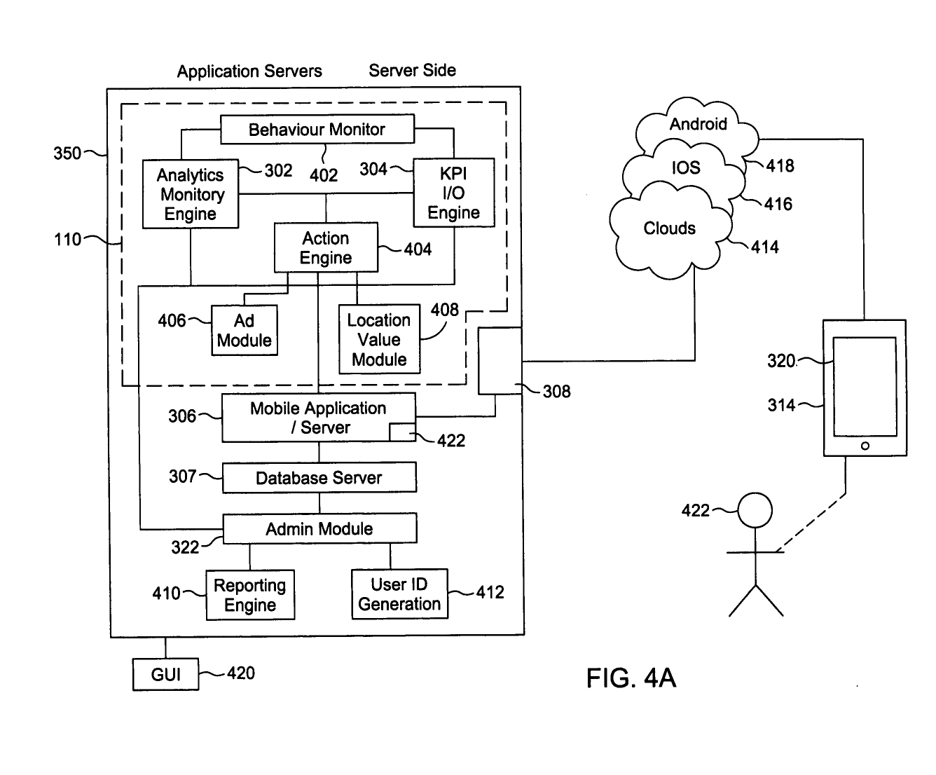

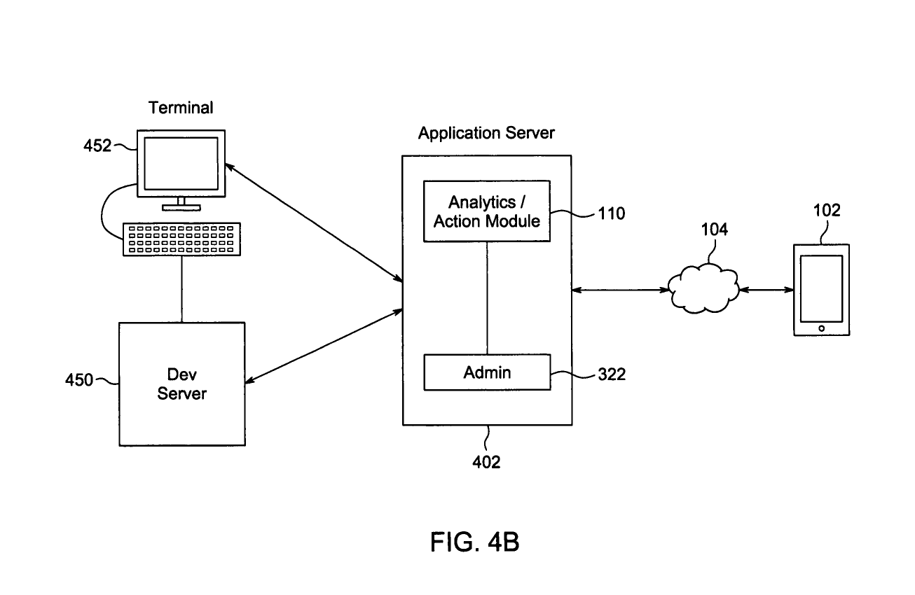

An admin module 322 may be further provided on the server side of the system, and in communication with each of the module 110, the application server 306, database server 307 and cloud server 308. The admin module 322 may allow the developer, also referred to herein as Merchant, of a the mobile app to perform predetermined functions, input key performance indicators, set trigger values, while also performing standard admin functions for the mobile apps, each of which will be discussed with more detail with relation to FIGS. 4-6. For example, using this module, constraints set by the merchant, and revising pricing based on performance data. Performance data includes both including purchase decisions observed as well as ingestion of other data, such as customer demographics and purchase history not directly observed by the platform.

The admin module 322 further to above and below, may be configured to display though the GUI, reports and trends of all customer activity (e.g. location, demographic, ARPU, average level reached, etc.). The admin module may further be configured to show show one time depositors (OTDs) for example, so that the developer knows this user needs to be “awoken” to make another deposit. In the admin module, all KPI data of player activity will be available, which assists the developer in configuring settings and/price and offer indicia.

The admin module 322, together with the KPI and behavior engines, through tracking KPI data such as ARPU and LTV, is configure to calculate ROI (based on the users input on marketing expenditures), such that the system can automatically build and manage marketing campaigns to meet ROI requirements, while also setting appropriate and optimized triggers.

Further the module/invention will measure social influence of the game to understand if getting customers at no cost via social media/sharing etc, and could use virality with developers twitter or facebook or similar to help acquire customers.

Further, using the Admin module, the merchant or its staff administers may use the platform through a control panel built on platform interfaces (e.g., GUI), while the merchant's application interfaces directly with the platform API. In this way, the merchant has the ability to set and send:

an offer set;

an eligibility constraint;

an input variable constraint;

an individual offer constraint;

a relative offer constraint;

an offer set constraint;

an offer stickiness constraint; and

a constraint set.

In exemplary embodiments of the present invention, the merchant may configure more than one constraint set that are concurrently in effect. Optionally, one of the constraint sets may be identified as a “baseline” and have no or limited variation allowed, in order to demonstrate the performance advantage of using the platform.

In exemplary embodiments, of the present invention, the merchant can set a mix weight constraint on the minimum and maximum weight to allocate to each constraint set. The platform can vary the weighting, according to performance of the various constraint sets, within the mix weight constraint.

Still referring to FIG. 3, each client 310, 312, 314 is a networked enabled smart phone. Like the client of FIG. 2, the smart phones 310, 312, and 314 may comprise a CPU, a sensory representation (a visual, auditory, or tactile output such as a graphic display, a tone, or a vibration), a keyboard/touchpad, a microphone, a memory, memory storage, a graphical user interface and a network interface. In exemplary embodiments of the present invention, the smartphones have the ability connect to application stores (e.g., Apple App Store, Android Market, MiKandi, Amazon App Store and BlackBerry App World).

In an exemplary embodiment, a user may download App 316 onto his or her smartphone. The App 316 may comprise a social network gaming application, which may be a derivative of a MMOG. The App 316 may be a simulation social network game which involves various aspects of farm management such as flowing, planting, growing and harvesting crops, harvesting tress and bushes and tending to livestock. In this embodiment, the Mobile App 316 may be an Adobe Flash application. The mobile app 316 may be run by developers as a freemium business model, meaning that certain beginning portions of the game are provided for free, but a premium is charged for advanced features, functionality, or virtual goods. For example, a user may begin the game with an empty farm, and can earn free credits by performing certain actions such as ploughing fields and planting crops. After a certain “level” is reached, the user may begin to purchase, using actual currency, high-end items such as cherry trees or chickens. As the user progresses through levels, the user has the option of purchasing additional goods using actual currency. In this way, the user provides great value to the developers. In exemplary embodiments of the present invention, the module 110 is configured to increase the user value.

In another exemplary embodiment of the present invention, the user at smartphone 312 may download a mobile App 318. The App 318 may be a social poker tournament or a blackjack game in which a user can enter a virtual casino lobby and join tables with his or her friends or other users on the network for a game such as Texas hold 'em of five card stud. In this embodiment, users provide value to the developer by entering certain information in exchange to sit down at a table, thereby allowing the developer to utilize targeted advertising to increase user value. Also, developers may rely on user registration and the amount of time a user spends on game for advertising revenue. Again, in exemplary embodiments of the present invention, the module 110 is configured to increase the user value.

In another exemplary embodiment of the present invention, the user at smartphone 314 may download another different App 320. The App 318 may be Sim-style game which users complete min-challenges and puzzles to earn money and unlock certain prizes. This game play is similar to in the sense that users are encourage to use actual currency to purchase in game tools. However, in Smurf Village, mini-challenges in which users can achieve and unlock different levels are utilized thus giving the developer more information about how users play the game which leads to greater knowledge through analytics, which will be discussed more specially in reference to module 110.

With reference now to FIG. 4, a more detailed view of the server side 350 is shown generally at reference numeral 400. The exemplary embodiments shown in FIG. 4 will be described herein with reference to the exemplary embodiment of Smurf Village Application 318. Server side 350 comprises behaviour monitoring engine 402, analytics monitoring engine 302, KPI engine 304, action engine 404, ad module 406, location value module 408, reporting engine 410 and user ID generation module 412. The system may further compose a plurality of servers including mobile application/developmental server 306, database server 307, cloud server 308 and admin module 322.

The module 110, which comprises the behaviour monitoring engine 402, analytics monitoring engine 302, KPI I/O engine 304, action engine 404, ad module 406 and location value module 408, may be implementable or configurable with an existing gaming platform. For example, the module may be an application programming interface (API) that may be written into game Z 320 (Smurf Village). The module 110 is configured as a specification to be used as an interface by each of the components on the server side to communicate with each other. The module 110 may include specifications for routines, data structures, object classes, and variables, and may be implanted in any standard, for example, POSIX or vendor documentation such as the Microsoft Windows API, Standard Template Library in C++ or Java API.

The mobile application server 306, like in FIG. 3, may store a plurality of mobile apps or games that are downloadable onto smart phone 318 via network 414 416 and 418. As shown in this exemplary embodiment, the clouds may be for example an IoS cloud or an android cloud each representing a marketplace of data in which to request and retrieve certain mobile Applications. Other examples BlackBerry, HP webOS, Symbian OS, Bada and Windows Mobile. The mobile application server 306 may also act as a development server such that the developer can manage, expand alter game play.

In this exemplary embodiment, the user 422, which represents a plurality of users, each have download App 320 onto smart phone 314. In optional embodiments, game Z 320 may require the user to set up a first user or gamer profile the user information consists of details including, but not limited to, name, age, sex, location, areas of interest, dislikes, email address, hobbies, and occupation. Each of these attributes may be further stored in the database server 307, while also being communicated to the analytics monitoring engine 302 and KPI I/O engine 304.

The plurality of end users 422 may engage in game play of game Z 320. The behaviour monitoring engine 402, monitors user game play for each of the plurality of end users 422. The behaviour engine 402, in this way, can communicate with each of the KPI I/O engine and Analytic monitoring engine 302 to derive user behaviour or other implicit characteristics, which will be discussed in greater detail with reference to the present FIG. 4. The behaviour monitoring engine 402 may be configured to constantly query the App for certain behaviours and data. For example, when a user begins to play the game, the behaviour engine may enter query mode in which the engine is configured to monitor the user's behaviour while playing the game.

For example, as a user is progressing through game 320, the behaviour engine may be configured to monitor user actions. User actions may include specific in-game play, such as how a user is progressing through a level, which challenges a user has completed and how the user has completed them, the amount of time the user plays, the amount of time the user is on a specific level. Other user actions may comprise the amount of currency a user spends on product, when they spend it and how they spend it. The behaviour monitoring engine 402, in more general terms, is configured to sparse, for example, geography, engagement, retention, and monetization. The behaviour engine may monitor each user in real-time, and communicate said information to the analytics monitoring engine 404.

KPI Input/Output (I/O) engine 304, in this exemplary embodiment, is developer configurable. In this way, the developer can input a set of indicia that is relevant to a particular mobile application. For example, the KPIs may be a predetermined set of indicia that is dependent upon the mobile application the user is using/playing. In the exemplary illustration of game 320, it may be predetermined, using past analytical analysis, that a user who reaches a particular level will purchase a virtual good sixty percent of the time. This information can be uploaded into the KPI engine 304 to be used together by the behaviour engine 402, analytic monitoring engine 302 and action engine 404 to increase user value.

The KPI I/O engine 304 defines a set of values or indicia that using the behavioural engine, can be compared with input values. The values that the KPI engine may include raw sets of values that when input into the systems, define certain indicators. The indicators may include, for example, quantitative indicators which can be presented as a number, practical indicators that interface with existing developers processes, directional indicators specifying whether the mobile application as whole is increasing in value, actionable indicators are sufficiently in an organization's control to affect change, and financial indicators. These factors may, in exemplary embodiments, undergo comparative analysis with the data sets fed to analytical monitoring engine. Examples of said indicia may comprise, for example, unique active players per month per game, unique active players per day per game, percentage of male versus female players, average session length, and most popular time of day to play.

The KPI I/O engine 302, in exemplary embodiments, may be configured to measure, calculate, and dynamically assess the following indicia:

Average revenue per user (ARPU), in any predetermined period of time;

ARPU by demographic (e.g., country, sex, age, and combinations thereof;

number of deposits (purchases);

mean/median deposits/purchase;

frequency of deposits/purchases;

specific leakage predetermined parts of the game/application; for example, where players leave the game or discontinue use at a high level (e.g., if its a slot game for example, measure how long average loss of the credits that were purchased); and

value of a customer's network (measure how they share the application.

The above-described indicia may be coupled with solutions or actions which are intrinsically defined by an offer to the user or action by the system to increase user value. As one example, the action is a solution to customer leakage, via an offer to continue playing of an intrinsic feature in which the game becomes more exciting.

In another exemplary embodiment, the KPI engine 304 is configured to calculate what marketing cost should be based on predetermined data, and alert the developer how/where to expend capital it in order to decrease customer acquisitions costs. In this exemplary embodiment, the data received from the behaviour monitor 402 enables the KPI I/O engine to format a refer-a-friend model into the application by distinguishing which incentives are needed for both the referrer and the referee.

With reference still to FIG. 4a, the analytics monitoring engine 302, which is in communication with each of the behaviour engine 402 and KPI engine 304, is configured to transform the data received by the behaviour engine 402 into a usable form, while making real-time and predicative analyses using comparative analyses to input KPI data. For example, as the mobile app 320 is being executed on smartphone 314, the analytics monitoring engine 302, which comprises any combination of hardware and/or software is configured to measure, calculate and send data associated with the mobile app 302. For example, the analytics monitoring engine 302 may be configured to receive performance, event and/or feature information associated with the mobile application through the use of an API as described in FIG. 3. The analytics monitoring engine 302 may be configured to receive information according to a predetermined schedule. In optional embodiments, the analytics monitoring engine 302 may receive the information in real time, while in other optional embodiments, the analytics monitoring engine 302 may receive the information at an occurrence of a predetermined event (e.g., a user making it to a certain level of a game) and other indicia provided herein

The analytics monitoring engine 302 may be further be configured to send all received data to the database server 307 for archive and storage. In optional embodiments, the analytics monitoring engine 302 can send all received data to an offsite database server over a network such as those described in FIGS. 1-3 or the clouds 414-418.

Furthermore, the analytical monitoring engine 302 may be further configured as a learning machine. For example, the analytical monitoring engine 302 may be configured to as predictive, based on the data received from the KPI engine 304. The analytical monitoring engine 302 may be further configured to mine data in conjunction with in the database server 307, and configured for Knowledge Discovery in Databases (KDD) to discover previously unknown properties of the data received. Examples of analytical monitoring engine 302 learning may include supervised and unsupervised learning, or as a pre-processing step to improve learner accuracy.

The module 110 may further comprise an action engine 404 which, in response to a signal from analytical monitoring engine 302, is configured to perform a predetermined action which is designed to increase user value from the perspective of the developer. For example, in the recurring exemplary embodiment of the user who reaches a particular level will purchase a virtual good sixty percent of the time, the action engine 404 may prompt a user at that time to perform an action that increases user value.

In an exemplary embodiment of the present invention, the use actions are configurable by the developer. For example, analytics monitoring engine 302 may provide the developer suggestions as what items a developer should incentivize to increase user value. The actions to be taken then, can be configured by the developer using admin module 322.

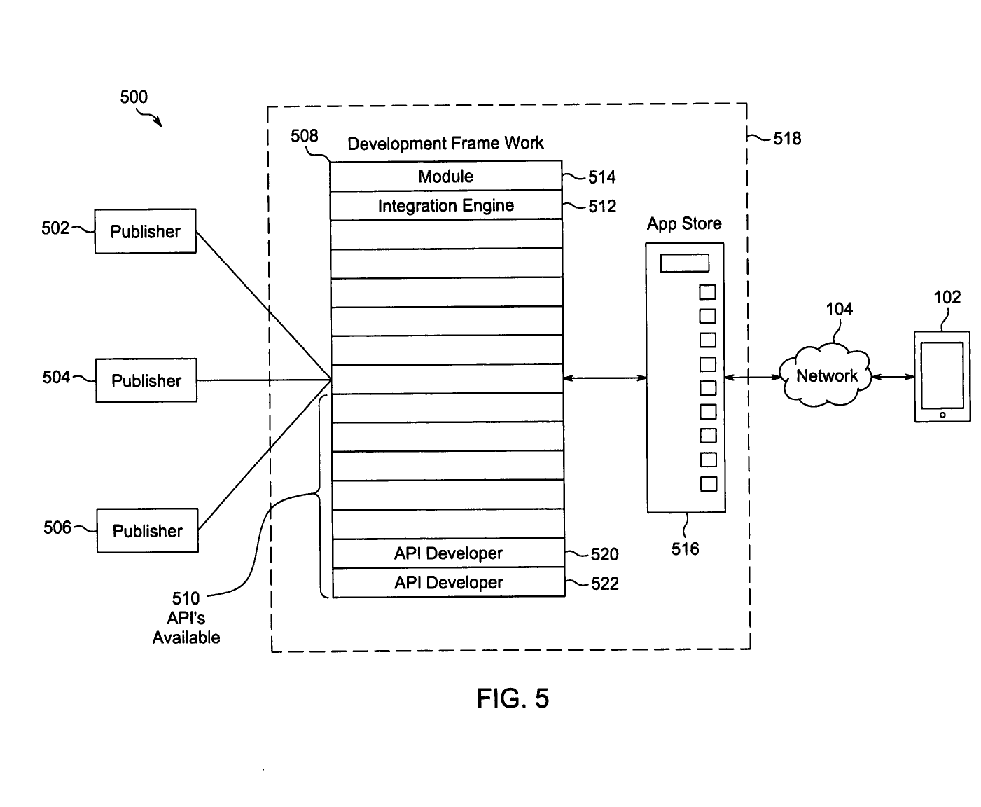

In this embodiment, the monitoring engine 302 may monitor a user's gameplay, and communicate to the developer (see FIG. 5) which actions may be set to increase the value of the user. Via admin module 322, the developer may have the ability to set the action to his or her specifications, based on budgetary constraints, business models and user user/customer relationship concerns. In this regard, the system 300 is further configured to post or communicate specific action suggestions for actions to be taken, along with quantitative data associated therewith.

As seen in FIG. 4b, a dev server 450 is in communication with the developer terminal 452. The analytics engine 110 on application server 402 comprises those modules and engines shown in FIG. 4a and is configured to perform analogous functions. The terminal is configured to communicate with dev server 450 and also app server 402. The analytics engine 402 is further configured to send messages to the developer at terminal 452. For example, if during a game the analytics module shows that a current user is ripe to be pushed into a new segment of a game via real time engagement, an action can be triggered to message the user device. However, in this exemplary embodiment, the developer at terminal 452 may approve the action, and set the specifics of the action at budgetary or developer discretion. The performance of the offers or actions are dynamically measured based on return-on-investment (ROI) configurable parameters, to stop, slow, increase etc. In this way, the present system 300 identifies new and useful ROI opportunities and optimizes those as well.

With reference back to FIG. 4a, action engine may comprise, or be in communication with, ad module 406 and location value add module 408. The ad module 406 may be preloaded with advertising components or advertising messages. The action engine 404, upon the occurrence of an event, may be configured to execute an ad on the ad engine 404. For example, company X may wish to advertise on a platform of the mobile application. In exemplary embodiments of the present invention, the ad module may be configured to push a Mobile Web Banner or Mobile Web Poster to the smart phone 314 for viewing by the user. In optional embodiments the ad module 406 may be configured to utilize SMS, MMS or Push messages to a plurality (or individual) users.

The module 110 may further comprise location value module 408 in communication with the ad module and the action engine. The location value module may utilize the smartphones global positioning services built into the phone, or use radiolocation and trilateration based on the signal-strength of the closest cell-phone towers (for phones without GPS features). In this way, the value add components of the module can be location specific, thereby increasing advertising value.

The module 110 may in communication with mobile application server 306. The mobile application server 306 may store a plurality of mobile apps or games that are downloadable onto smart phones 310, 312, 314 via network 104. Like the application of server of FIG. 3, the mobile application server 306 may be a dedicated application server for running certain software applications (e.g., gaming). The mobile application server 306 may be any combination of hardware and/or software configured to execute one or more applications. The server side application 422 which resides on the mobile application server 306, for example, may be configured to execute an a plurality of systems including gaming, e-mail server applications, and/or other application configured to provide functionality to one or more client devices.

The mobile application server 306 may be operatively coupled to a global network (clouds 414, 416, 418) through cloud servers 308. The mobile application server 306 may be directly connected to the network as well, such that the server side application 422 is configured to send and receive signals which include mobile application data.

Referring now to FIG. 5, in an exemplary embodiment of the present invention, a system architecture for use in the context of mobile App development is shown generally at 500. In this embodiment, a plurality of publishers 502, 504, 506 may be in the process of developing a mobile App, still in process of development but launched, or completed development and launched. Embodiments of the invention are applicable in each of these scenarios.

In a first scenario, publisher 502 is developing a mobile application but has not launched the mobile application in the App store 516. The publisher 502, may use, for example, a software development kit (SDK) which that allows for the creation of applications for a certain software package, software framework, operating system, or similar platform. In this exemplary embodiments, predetermined data may be collected to configure an at least one of a plurality of user configurable APIs 510 which are available on developmental framework 508.

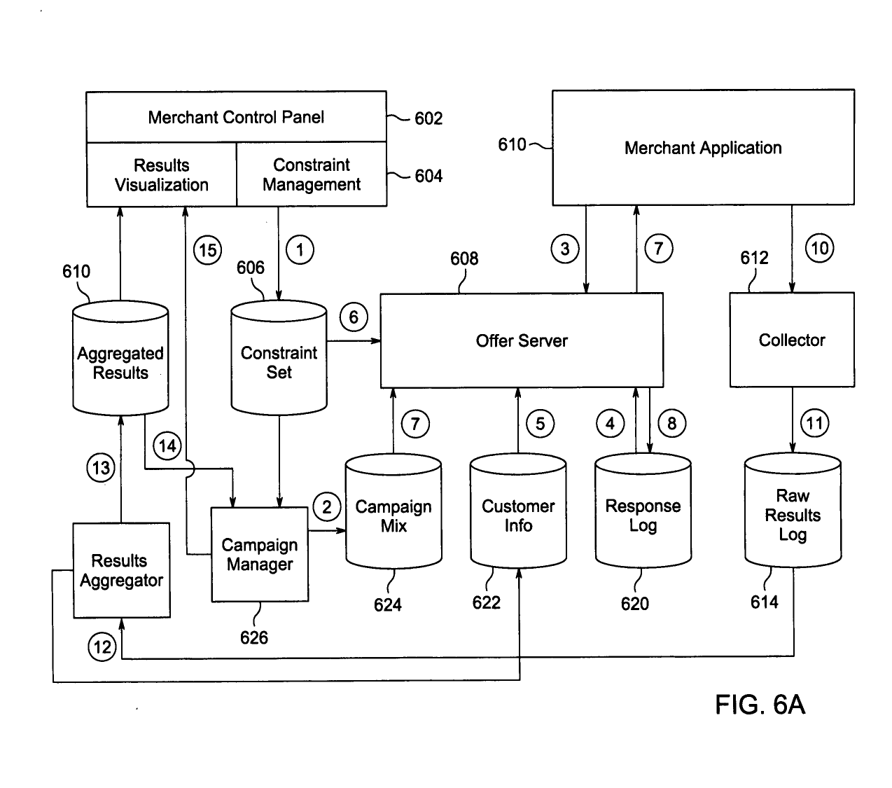

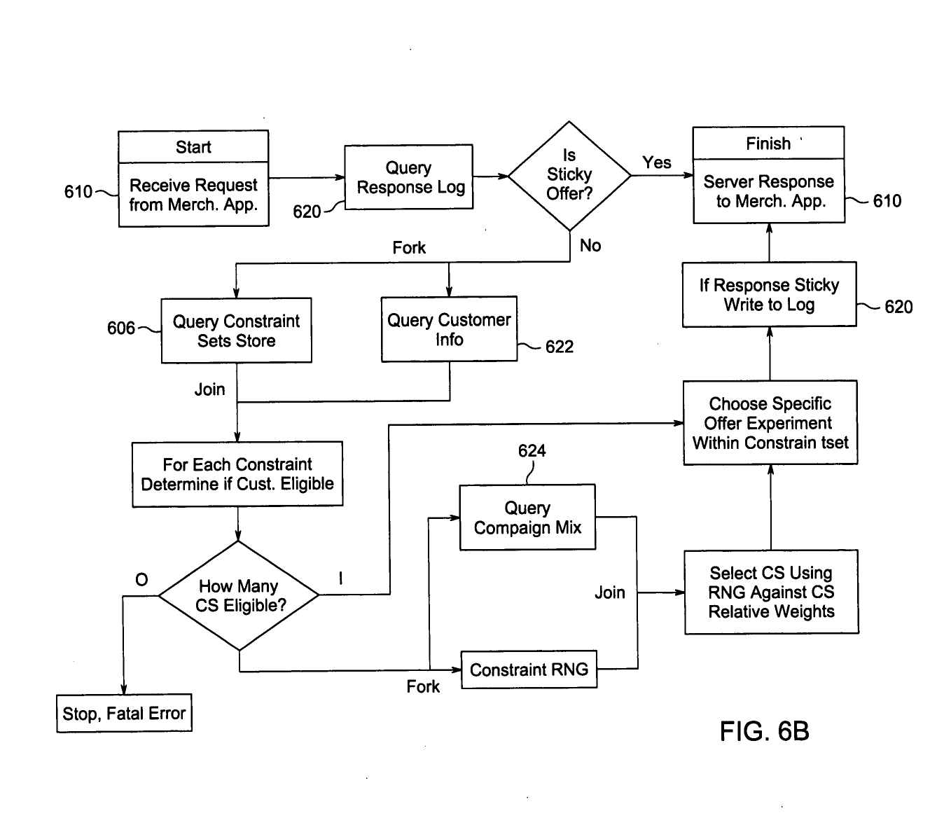

The developmental framework 508 may be third-party webserver which houses the plurality of APIs 510 and available to a publisher at cost, which will be discussed in more detail with relation to FIG. 6a. The APIs 510 may comprise information generally associated with particular versions of the mobile app as well as dynamic data to user configurable marks such as which mobile user are sharing with friends, where users are located, or any other of the plurality of KPI indicia the publisher chooses to associate with the mobile app.

The third party webserver 508 may further comprise an integration engine 512 which allows an API developer to provide an interface to a publisher to integrate a service to monitor and/or increase user value in mobile app without the developer having to alter base code of the mobile app. In operation, the integration engine 512 acts as an intermediate between API and the mobile application to obviate user configuration of the API or minimize it.

In this exemplary embodiment, the API, which provides and includes the components of FIG. 4a on the server side (e.g., all monitoring and KPI engines 110, behavior monitoring engines 402, admin modules 332, etc.) is available on the development framework 408 via app store 516.

In this embodiment, the API may be user configurable and or act as a suggestion engine. The API may be configured, based on predetermined data loaded into the APIs 510, which factors contribute the user value in a certain game type or online gaming. In this embodiment, a publisher may purchase the API 510 which is configured to comprise certain options for developer, each of which is configured to increase user value. For example, the API 510 may comprise a share/invite a friend built into as an option for the application and can manage that process of rewarding both based on the credits/business model of the application. For example, if the publisher expends X dollars on customer acquisition in the form of mobile marketing, once module 110 invention learns, via behavior monitor 402, the Life Time Values (LTVs) by the demographics, the module 110, embedded in API 520, is configured to automate mobile marketing for the publishers 502 application. In this embodiment, the API 510 may be configured to accept a budget and a set of rules (e.g., cost per day and time period, etc), and predict the LTV of the new users based on behavior of past users compared to the new users behavior, in real time, to show instant ROI. In this way, the API when used at the start of application development and during application use is an optimization engine.

Further, depending upon the selected API 519, the user configuration module 514 may allow the publisher to configure the API to publisher specification depending upon the indicia required or desired by the publisher to increase user value. The publisher may use the module 514 to set KPI indicia and parameters as well. The chosen APIs can be stored on the web server 514 for use at the publisher's desire. Referring back to scenario one, in which the publisher 502 is developing a mobile application but has not launched the mobile application in the App store 516, the publisher may select a certain predetermined KPI.

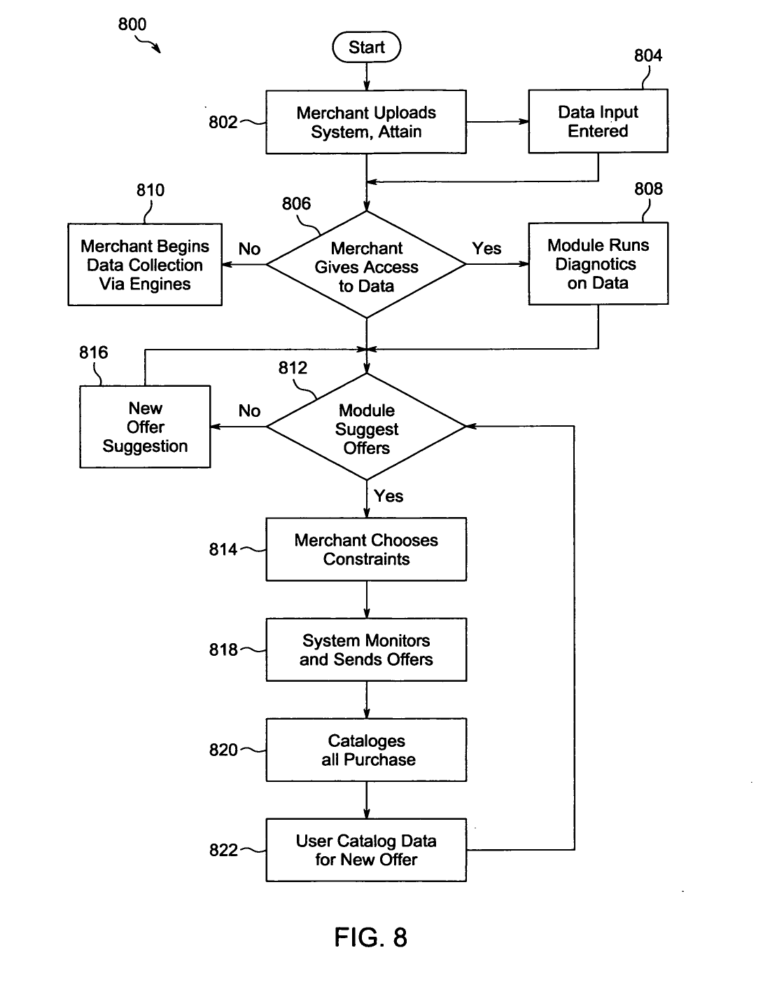

Referring now to FIG. 6a, a block diagram showing a system architecture applicable to embodiments of the present invention is shown generally at 600, together with communications to be explained with more detail in relation to FIG. 8. As shown herein, this embodiment includes a merchant control panel 602, constraints management 604, campaign manager 626, offer server 608, merchant application 610, a results collector 612, results aggregator 628, and a plurality of data storages, each represented in the diagram by a cylinder shape. As may be readily appreciated by a skilled artisan, data store and logic components may be combined, refactored, or distributed in order to optimize system scalability and maintainability. Each numbered arrow in FIG. 6a represents communicative coupling of the components, with the direction of the arrow indicates the dominant flow of the data. As may be readily appreciated by a skilled artisan, steps may be performed concurrently or in different sequences in order to optimize system performance.

The merchant control panel 602 is a GUI in communication with constraint management logic 604 (admin module 322) and results visualization logic 605. The merchant application 610 is in communication with the offer server 608. Associated with the offer server 608 is a results collector 612 receives results and status messages from the merchant application 610.

Now with reference to the numbered arrows in FIG. 6a, the merchant administrator on arrow #1 establishes a plurality of constraints through the merchant control panel 602, processed through constraint management logic 604 and stored in a data storage 606.

With arrow #2, the campaign manager 626 initializes the campaign mix which may be recorded in data storage 624, for use by the offer server 608. The campaign manager 626 queries for aggregated results in data storage 630, and as results become available, adjusts the campaign mix, within the campaign mix constraint set by the merchant. The campaign manager 626 contains logic so that campaign mix adjustments optimize financial return to the merchant, while preserving room for experimentation that even if suboptimal may lead to future performance enhancements.

With arrow #3, the merchant app 610 requests a pricing result from the offer server 608. Such requests may be batched and the response may be asynchronous. For each request, the offer server 608 follows the flowchart in FIG. 6b, showing how the offer server completes arrows #3 through #9 in FIG. 6a.

With arrow #4, the offer server 608 first queries a response log 620 to see if a previous result should be returned to the merchant application 610, as will be described for arrow #9. If this “shortcut” is not taken, the offer server 608 then queries the customer info data store 622 with arrow #5 and the constraint set data storage 606, which may be done in parallel. The offer server 608 then filters the available constraint sets to that the customer may be eligible for. Eligibility for an offer may be determined by attributes recorded in the customer info data store 622 as well as provided directly by the merchant application 610 when making the request to the offer server.

The offer server 608 then examines the number of constraint sets available for use in generating an offer response to the merchant application 610. If it is possible for the merchant to configure constraints set such that none are eligible or default, the offer 608 reports an error to the merchant application and also reports the error to the merchant control panel 602. If more than one set is available, the offer server 608 then with arrow #7 queries campaign mix data storage 624, a result which may be pre-fetched or cached. The offer server 608 then randomly or pseudo-randomly generates a number to select a constraint set, with a probability distribution that is weighted according to the values earlier assigned to each constraint set by the campaign manager 626. In an alternative embodiment, the offer server 608 may use precedence rules set by the merchant, or some other merchant-supplied logic to arbitrate between multiple eligible constraint sets.

Once the offer 608 has selected a constraint set, the offer server 608 fixes a specific offer within that constraint set. If the response is to have nonzero stickiness, the offer server 608 then records with arrow #8 the response in data store 620. Arrow #8 may be in performed in parallel or after arrow #9, where the offer server 608 returns an offer response to the merchant application 610.

The merchant application 610 sends results to the collector 612 in arrow #10, which are in turn recorded in a raw results log store 614. The results may be asynchronous or batched. The results may include status responses that indicate the customer decided not to buy anything, that the customer decision is still pending, or that the offer with withdrawn or expired.

With arrow #12 the results aggregator 628 queries the raw results log to update KPIs and other calculations that may be useful in current or future KPI calculations. With arrow #13 the results aggregator 628 writes such calculated values to the aggregated results data store 630, as well updates any customer-specific attributes in data store 622. The results aggregator 628 may also be used to ingest data from external historical sources.

With arrow #14 the campaign manager 626 continually evaluates the aggregated results and determines how to adjust the campaign mix as previously mentioned with arrow #2. The campaign manager 626 with arrow #15 also suggests new constraint sets for the merchant to consider. With arrow #16 the merchant may also perform ad-hoc exploration of the aggregated results in order to monitor performance, create new constraint sets, and use insights outside of the described system.

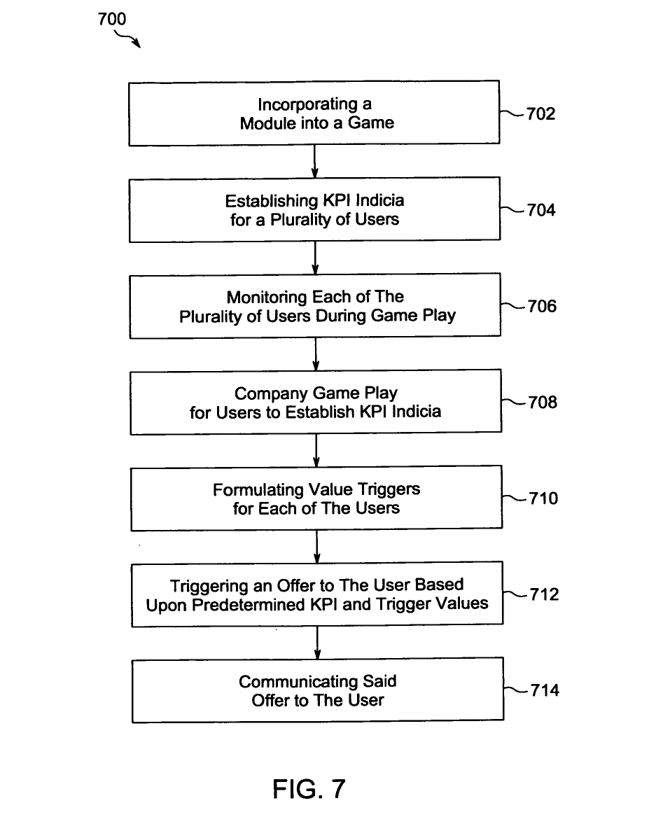

Referring now to FIG. 7, there is shown a flow chart to further illustrate a method for increasing user value in an online gaming environment, 600.

At step 702, a module 110 is provided such as that described with relation to FIG. 1. The module may comprise code which is incorporated into an online game. The module may be an API that is incorporated by the developer into an existing game. The module may be preconfigured with certain attributes, and is also fully configurable by the developer. The module 110 may comprise a behaviour monitoring engine 402, analytics monitoring engine 302, KPI I/O engine 304, action engine 404, ad module 406 and location value module 408, and may be implementable or configurable with an existing gaming platform. The module 110 is configured as a specification to be used as an interface by each of the components on the server side to communicate with each other. The module 110 may include specifications for routines, data structures, object classes, and variables, and may be implanted in any standard.

At step 704, KPI indicia is set for a plurality user, or in an optional embodiment, unique indicia is set for each user of a plurality of users. The KPI indicia may be based upon predetermined gaming factors or those learned during game play. For example, a KPI Input/Output (I/O) engine 304, in this exemplary embodiment, is developer configurable. In this way, the developer can input a set of indicia that is relevant to a particular mobile application. For example, the KPIs may be a predetermined set of indicia that is dependent upon the mobile application the user is using/playing. In an exemplary embodiment, the indicia may be predetermined, using past analytical analysis. This information can be uploaded into the KPI engine 304 to be used together by the behaviour engine 402, analytic monitoring engine 302 and action engine 404 to increase user value. Examples of KPI indicia include ARPU, in any predetermined period of time, ARPU by demographic (e.g., country, sex, age, and combinations thereof), number of deposits (purchases), mean/median deposits/purchase, frequency of deposits/purchases and specific leakage predetermined parts of the game /application; for example, where players leave the game or discontinue use at a high level (e.g., if its a slot game for example, measure how long average loss of the credits that were purchased).

At step 706, the module 110 is configured to monitor the actions of the user. The behavior monitoring engine 402 is configured to track, in real-time, all players movements and actions. The behavior monitoring engine 402 is configured to communicate with each of the KPI I/O engine and Analytic monitoring engine 302 to derive user behaviour or other implicit characteristics, which will be discussed in greater detail. Furthermore, the behaviour monitoring engine 402 may be configured to constantly query the user game For example, when a user begins to play the game, the behaviour engine may enter query mode in which the engine is configured to monitor the users behaviour while playing the game.

At step 708, the module compares the user's game play to the KPI indicia in real time. For example, the as a user progresses through a game, or engages in online gaming, the data garnered from the behavior engine compares the data retrieved from the behavior engine to the established indicia from step 604.

Formulating value triggers, step 710, may comprise setting actions which are configurable by the developer. In an embodiment, the module may be preloaded with predetermined trigger values. In other embodiments, the module 102 may provide the developer suggestions as what items a developer should incentivize to increase user value. For example, module 110 may monitor a user's gameplay, and communicate to the developer (see FIG. 5) which actions may be set to increase the value of the user. Via admin module 322, the developer has the ability to set the action to his or her specifications, based on budgetary constraints, business models and user user/customer relationship concerns. In this regard, the system 300 is further configured to post or communicate specific action suggestions for actions to be taken, along with quantitative data associated therewith.

Triggering an offer to the user step 712 may comprise comparing the formulated values at step 710 to the to the established KPI indicia established at 704. If a predetermined established KPI value is reached by the formulated values, an action is triggered. For example, the action engine may send an advertising message to a user. For example, the ad module may be configured to push a Mobile Web Banner or Mobile Web Poster to the smart phone 314 for viewing by the user. In optional embodiments the ad module 406 may be configured to utilize SMS, MMS or Push messages to a plurality (or individual) users.

At step 714, the value propositions or offers are communicated to the user.

While the flowchart shows an exemplary step-by-step method, it is to be appreciated that a skilled artisan may rearrange or reorder the steps while maintaining like results.

Now with reference to FIG. 8a shows a step-wise diagram for a method of optimizing user value and setting price schema also with reference to the components of FIG. 6a. In step 802, the merchant performs initial configuration of the system through the merchant control panel 602. In step 804, 806 and 808 the merchant may provide historical data for ingestion by the results aggregator 628. Step 810 describes the operation of the system 600 while no new offers are being generated by the campaign manager 626. Steps 812 and 816 are executed by the campaign manager 626.

When in step 812 a new offer is proposed by the campaign manager 626 through the control panel 602 and more specifically 605, the merchant may then in step 814 approve or create new offer constraints using the control panel 602 and more specifically 604. In step 818 and 820, a combination of the offer server 608 and collector 612 may be used to monitor the new offers. In step 822 the results aggregator 628 runs and may result in the campaign manger 626 generating new offers.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

Although specific features of various embodiments of the invention may be shown in some drawings and not in others, this is for convenience only. In accordance with the principles of the invention, the feature(s) of one drawing may be combined with any or all of the features in any of the other drawings. The words “including”, “comprising”, “having”, and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

We claim:

1. A method for optimizing end-user value for a web or mobile application, the method executed by one or more computing processors, the method comprising:
monitoring an end-user behavior on the application;
analyzing the end-user behavior; and
performing an action based on the analysis, wherein the action comprises transmitting an offer to the end-user or setting an indicia by a merchant.

2. The method of claim 1, further comprising:
providing an application programming interface (API) that is integratable with the application, wherein the API comprises a module which interfaces with merchant application, the module being configured to execute the method.

3. The method of claim 1, further comprising:
establishing key performance indicator (KPI) indicia for at least one of a plurality of end-users, wherein the KPI indicia is merchant configurable and viewable, the KPI indicia comprising:
average revenue per user (ARPU), in any predetermined period of time;
ARPU by demographic;
number of deposits or purchases;
mean/median deposits or purchase;
frequency of deposits or purchases;
specific leakage; and
value of end-users network.

4. The method of claim 3, wherein the KPI indicia is fully configurable by the merchant using an administration module and graphical user interface.

5. The method of claim 1, further comprising:
comparing the monitored end-user behavior to the KPI indicia;
determining a value for an action;
confirming the value with the merchant; and
transmitting the action to the user.

6. The method of claim 1, further comprising:
collecting end-user demographic data; and
comparing end-user behavior to the end-user demographic data;
formulating the action based on the comparison.

7. The method of claim 1, wherein the module is configured to provide a predetermined set of indicia that is merchant selectable.

8. The method of claim 1, further comprising:
setting offer constraints, wherein the offer constraint is configurable by the merchant, and wherein plurality of actions defines a campaign;
initializing the campaign at the GUI, the campaign being a mixed campaign;
adjusting KPI indicia according to the end-use behavior;
transmitting a campaign result to the merchant;
optimizing the KPI indicia to result in greater value; and
repeating the optimization step on a continuous basis.

9. The method of claim 8, wherein the constraints comprise:
an eligibility constraint;
an input variable constraint;
an individual offer constraint;
a relative offer constraint;
an offer set constraint;
an offer stickiness constraint; and
a constraint set.

10. A processor-based system for optimizing end-user value for a web or mobile application, the system comprising:
a module in communication with the application, wherein the module is configured to:
monitor an end-user behavior on the application;
analyze the end-user behavior; and
perform an action based on the analysis, wherein the action comprises transmitting an offer to the end-user or setting an indicia by a merchant.

11. The system of claim 10, wherein the module comprises an application programming interface (API) that is integratable with the application, the module configured for communication with a server and a client using a network.

12. The system of claim 10, further comprising:
a key performance indicator (KPI) module configured to establish KPI indicia for at least one of a plurality of end-users, wherein the KPI indicia is merchant configurable and viewable, the KPI indicia comprising:
average revenue per user (ARPU), in any predetermined period of time;
ARPU by demographic;
number of deposits or purchases;
mean/median deposits or purchase;
frequency of deposits or purchases;
specific leakage; and
value of end-users network.

13. The system of claim 12, further comprising an administration module in communication with the network, wherein the administration module is configured to:
allow a merchant to configure the KPI indicia via a graphical user interface;
determining a value for an action;
confirming the value with the merchant; and
transmitting the action to the user.

14. The system of claim 12, further comprising:
a behavior engine in communication with the application and configured to comparing the monitored end-user behavior to the KPI indicia.

15. The system of claim 10, wherein the system further comprises:
a memory and storage configured to collect and store end-user demographic data; and
a campaign manager in communication with administration module, and configured to compare end-user behavior to the end-user demographic data and formulate the action based on the comparison.

16. The system of claim 10, wherein the module is configured to provide a predetermined set of indicia that is merchant selectable.

17. The system of claim 15, wherein the campaign manager is configured to set offer constraints, wherein the offer constraint is configurable by the merchant, and wherein plurality of actions defines a campaign, the campaign manager configured to:
initialize the campaign at the GUI, the campaign being a mixed campaign;
adjust KPI indicia according to the end-use behavior;
transmit a campaign result to the merchant;
optimize the KPI indicia to result in greater value; and
repeating the optimization step on a continuous basis.

18. The system of claim 17, wherein the constraints comprise:
an eligibility constraint;
an input variable constraint;
an individual offer constraint;
a relative offer constraint;
an offer set constraint;
an offer stickiness constraint; and
a constraint set.

19. The system of claim 10, wherein the module is further configured to:
accept an offer constraint, wherein the offer constraint is a budget, and apply logic to predict a long term value of a new end-user based on behavior of past end-users based to predict an instantaneous return on investment.

20. The system of claim 10, wherein the module is configured to provide suggestions based on end-user demographics at integration into the application.
